(19) United States
(12) Patent Application Publication
(10) Pub. No.: US 2011/0145525 A1
(43) Pub. Date: Jun. 16, 2011

(54) Method and System for Storing and Operating on Advanced Historical Access Data

(75) Inventors: Michael E. Browne, Staatasburg, NY (US); Eli M. Dow, Poughkeepsie, NY (US)

(73) Assignee: INTERNATIONAL BUSINESS MACHINES CORPORATION, Armonk, NY (US)

(21) Appl. No.: 12/637,088

(22) Filed: Dec. 14, 2009

(51) Int. Cl. G06F 12/16; G06F 12/00; G06F 17/00

(52) U.S. Cl. 711/161; 711/170; 707/609; 707/E17.005; 711/E12.001; 711/E12.103

(57) ABSTRACT

Storing and operating an information object. An indicator associated with the information object is read. The indicator indicates that a historical information is stored for the information object. Responsive to determining from the historical information that the information object has been historically accessed, (a) future access time based on the historical information is determined; (b) a trigger for placing the information object in a storage device at a predetermined time before the future access of the information object is scheduled, the trigger being associated with a scheduled time; and (c) responsive to the scheduled time elapsing, the trigger is executed. When the trigger is executed, the information object is placed in said storage device.

### TECHNICAL FIELD

The present invention relates, in general, to managing an information object stored in a storage device or medium.

### BACKGROUND

In an environment comprising a plurality of storage devices connected through a network, information objects may be migrated among storage devices to improve information access efficiency. The information objects, such as files, are migrated to a storage device with a lower operating rate or to a storage device with a higher performance rating. Current algorithms involve the use of least recently used storage hierarchy mechanisms based upon frequency of access to the information object stored in the storage device, the performance of each storage device, the cost, etc.

### BRIEF SUMMARY

According to one embodiment of the present invention, a computer implemented method, system, and program product is provided for storing and operating an information object. An indicator associated with the information object is read. The indicator indicates that a historical information is stored for the information object. Responsive to determining from the historical information that the information object has been historically accessed, (a) future access time based on the historical information is determined; (b) a trigger for placing the information object in a storage device at a predetermined time before the future access of the information object is scheduled, the trigger being associated with a scheduled time; and (c) responsive to the scheduled time elapsing, the trigger is executed. When the trigger is executed, the information object is placed in said storage device.

According to another embodiment of the present invention, a database comprising the historical information is updated with an updated historical information regarding the information object responsive to the information object being accessed.

According to another embodiment of the present invention, an optimal placement of the information object into the storage device is determined based on a predetermined policy.

According to another embodiment of the present invention, the predetermined policy comprises a policy selected from the group consisting of a placement policy, a storage management policy, and a storage hierarchy.

According to another embodiment of the present invention, the historical information comprises a historical access time.

According to another embodiment of the present invention, the indicator is a bit.

According to another embodiment of the present invention, the predetermined time is determined based upon the historical information.

According to another embodiment of the present invention, the historical information is updated when the trigger is executed.

### BRIEF DESCRIPTION OF THE SEVERAL VIEWS OF THE DRAWINGS

FIG. 1 depicts one embodiment of a data processing network to incorporate one or more aspects of the present invention.

FIG. 2 depicts a detailed embodiment of one or more aspects of the present invention.

FIG. 3 depicts an embodiment of a process for when a file is used in one or more aspects of the present invention.

FIG. 4 depicts one embodiment of a flowchart describing one or more aspects of the present invention.

FIG. 5 depicts one embodiment of a processing environment to incorporate and use one or more aspects of the present invention.

FIG. 6 depicts one embodiment of a computer program product to incorporate one or more aspects of the present invention.

### DETAILED DESCRIPTION

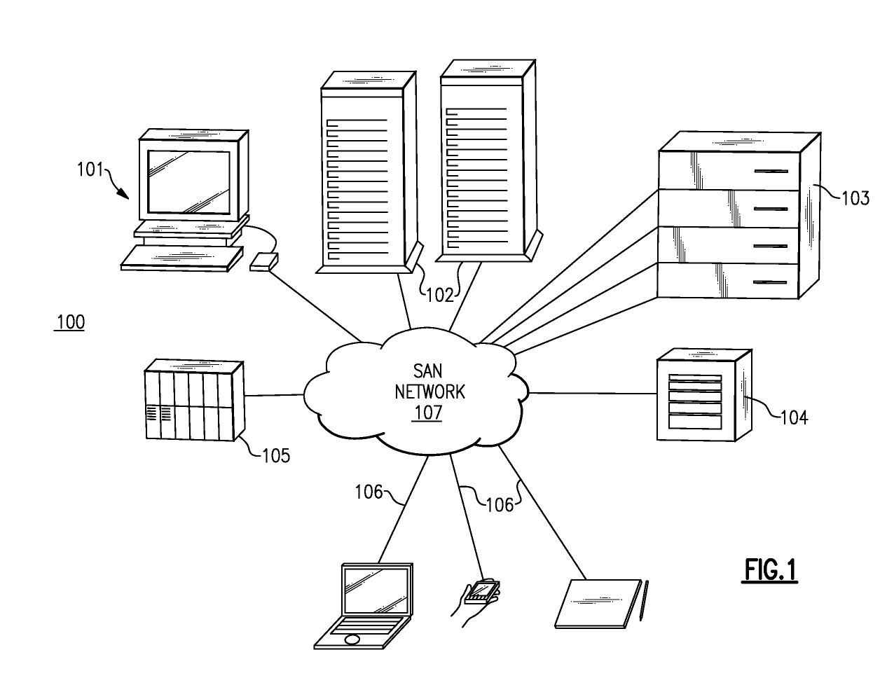

FIG. 1 illustrates a data processing network 100 in which the present invention may be practiced. The data processing network 100 may include a plurality of individual networks, such as a wireless network and a wired network, each of which may include a plurality of individual workstations 101, servers 102, rack servers 103, network access server (NAS) 103, redundant array of inexpensive disks (RAID) 105, and portable computer devices 106 which may include laptops, personal digital assistants, and other various computing devices. The data processing network 100 may also include other storage devices not listed above. Additionally, as those skilled in the art will appreciate, one or more storage area networks (SANS) 107 or local area networks (LANs) may be included.

Still referring to FIG. 1, the networks may also contain persistent storage units, such as a plurality of individual workstations 101, servers 102, rack servers 103, NAS 103, RAIDs 105, and other portable computer devices 106. These persistent storage units may contain information objects, such as files. The workstations 101 and other portable computing devices 106 may access data from the persistent storage units through the SAN by means of a communications link.

In one embodiment of the present invention, information object or file management is extended to include historical access statistics to enable optimal placement of files. A file is a named piece of data that is referenced by workloads and can be relocated in the data management system. For convenience purposes, the term “file” and “information object” are used interchangeably. Historical access statistics include a sizable class of access data that may be predictable in terms of time period (i.e., days, weeks, months and years) access patterns. An indicator in file metadata (i.e. an inode) along with historical access statistics may be used to analyze, on a periodic or event basis, patterns and cycles of particular file data in a file data repository. A historical access log may be created containing historical access statistics to enable optimal file data placement over time. Upon completion of the analysis, the analysis output may drive scheduled tasks into the data management facility. These scheduled tasks may allow for the optimal placement of file data, so that the file data will be placed prior to a predicated file access event in the future. These scheduled tasks may also allow for the movement of file data from an optimal placement for near-in-time access to an optimal placement for infrequent access.

In one embodiment of the invention, the indicator in file metadata (i.e. an inode) may be a flag, for example a single bit. This flag may indicate that historical point-in-time information is kept for a particular file. This bit may be set at any time during the life cycle of the file. In another embodiment of the invention, a bit may be stored at the dnode level (a data structure, for example, in a Unix® or Linux® system) indicating all elements within a directory is using a metadata system with the indicator. In another embodiment, a bit may be stored in an external database system which would indicate that the same historical access recording mechanisms, as described previously, should be enabled. In another embodiment of the invention, a Linux file system may be used. The Linux file system, as discussed in “Anatomy of the Linux file system” by M. Tim Jones, Oct. 30 2007, is incorporated herein by reference.

One embodiment of the present invention may optionally include the ability through management services to set policies to configure the size, location, and field for each record in the historical access log. The present invention may also include the ability to configure the pattern matching ability to enable easier configuration of files that have historical access statistics.

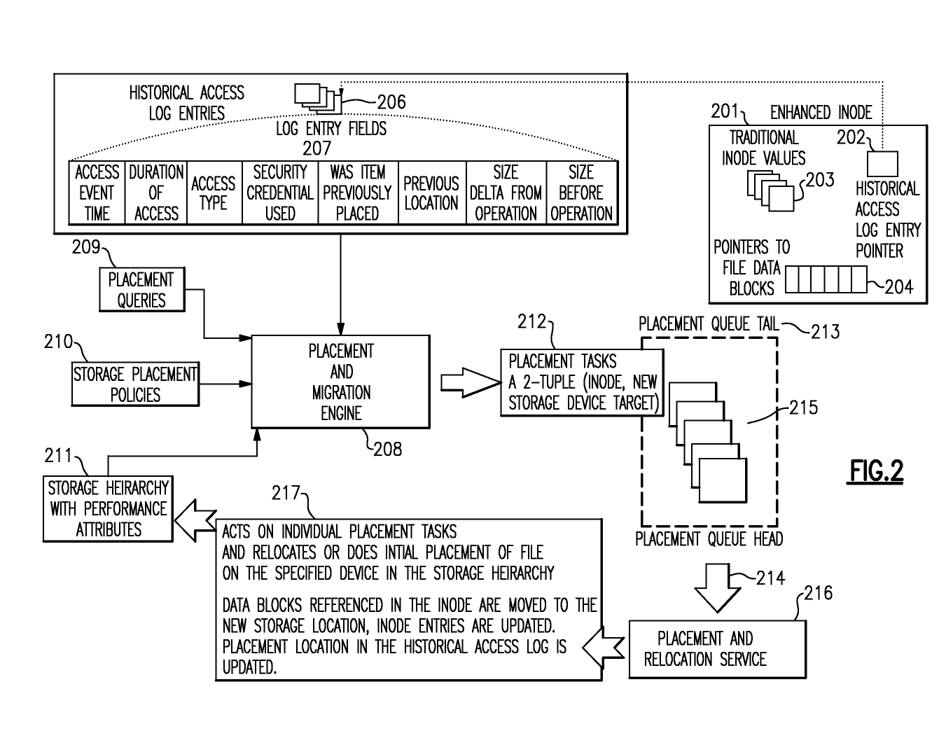

FIG. 2 describes one embodiment of one or more aspects of the present invention. An enhanced inode 201, which is a type of data structure (for example, in Unix® or Linux®) known in the art that contains file metadata, represents the information used in migrating file data in the present invention. An inode may include a historical access log entry pointer (Hbit), traditional inode values 203, and pointers to file data blocks 204. The Hbit points to the location of a historical access log entries 205. For example, if the HBit pointer is set, then there is additional metadata, however if the pointer is null or 0, then there is no additional metadata available for this inode. Traditional inode values may include file metadata such as type of file, the owners user ID, guide (a group ID), and username as well as other security tokens (for example, file permissions) used to access the file. Data stored in the inode may include other relevant data not listed above.

A Placement and Migration Engine 208 receives multiple inputs for its analysis of where to optimally place a file. These inputs may include the historical access entries 205, placement queries 209, storage management policies 210, and storage hierarchy with performance attributes 211. The historical access log entries 205 are made up of historical access information. The historical access log entries 205 may include individual log entries 206 that may further include multiple log entry fields 207. These log entry fields 207 may include access event time, duration of access, access type, security credential used, was item previously placed, previous location, size delta from operation, and size before operation. Other examples of entry fields, which represent other metadata that may be updated, include read time, write time, average delay in read time from last read, average read time from last write, average write time from last write, average write time from read. Entry fields may further include other relevant fields not listed above.

The placement queries 209 are predefined policies which determine where files are generally placed. For example, if there is a lull in the entire system, then the placement queries may define whether the system should start file migration during that lull. Also for example, files may be placed or migrated regardless of how busy the system is if there is a policy stating that the need for those files outweighs the performance impact in placing those files. The storage management policies 210 are policies based on predefined business rules. For example, certain business rules may dictate that certain files have to be stored in certain types of secured servers or storage devices. The storage hierarchy with performance attributes 211 is a database of characteristics for the various devices connected to the network. These characteristics may include the speed, size, workload, and other characteristics of the various storage devices.

The placement and migration engine takes the four inputs, 206, 209, 210, 211, and produces a work order of placement tasks 212 which determines which file should be placed in which storage device. The method for this determination is well known in the art, for example as would be normally done in a hierarchical storage manager such as IBM Tivoli Storage Manager®. The placement tasks 212 are ordered in a queue 215. The queue has a placement queue head 214 and a placement queue tail 213. The queue 215 may be reordered by the placement and migration engine based on file access events or policy changes. The reorder may be done manually by a user, for example through an administrative interface.

The placement and relocation service 216 then optimizes the queue through an analysis of its historical access log entry 207. The placement and relocation service determines when the files should be migrated to the optimal server in order to achieve optimal results. This analysis operates at some configurable or static interval (time or event based) and operates on historical file access information for analysis. During analysis, it is determined when the file has historically been accessed (particular days of month, quarter, year, interval between accesses and length of access). For example, the analysis may determine when to migrate the information to another storage device by taking into account the transfer rate (TR) from the various storage devices and the file sizes (S) of the data to be moved. For example, (1/TR)*S may be used to determine how long the file would take to transfer. This calculation, along with the day, month, quarter, year, etc based on historical access, would determine the time and date the file was to be speculatively moved.

Based upon that analysis, database triggers, not shown in the FIG. 2, are then scheduled, for example to run on a specific time, day, month, quarter, year, etc, so that a speculative file placement optimization in the storage hierarchy may occur. These triggers are software customizable actions that the system can take in response to a stimulus. For example, a database trigger may be scheduled for a database to start a task to place the file optimally a day before the specific date a file is historically accessed.

When the file migration is triggered, for example because the schedule date has been triggered, the placement tasks are acted upon, 217. Data blocks referenced in the inode are moved to the new storage location. Inode entries and historical access log entries are updated to take into the account the new storage locations.

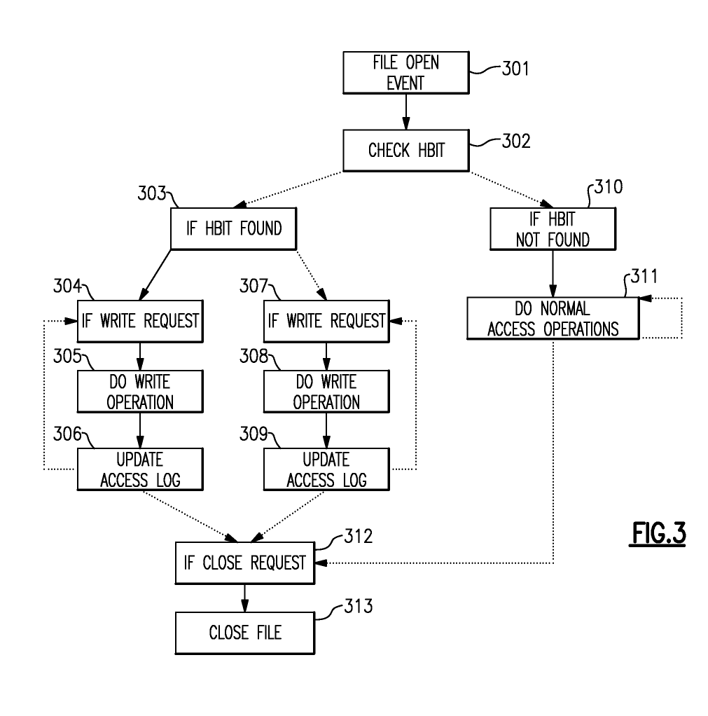

FIG. 3 describes an example of an embodiment of a process for when a file is operated on in an aspect of the present invention. When a file is opened 301, a historical access pointer (HBit) 302 is checked. If the HBit is not found 310, normal file access operations are performed until a close request 312, where the file is then closed 313. If the HBit is found 303, the file is then processed. If there is a write request 304, then the write operation is performed 305. The historical access entry (log) is then updated 306 to include any access time or other historical information. Any additional write requests are processed until all the requests are complete and closed 312. Similarly, if there is a read request 307, a read operation is performed 308. The historical access entry (log) is then updated 309 to include any access time or other historical information. Any additional read requests are processed until all requests are complete and there is a close request 312. The file is then closed 313.

In one embodiment of the present invention, when I/O operations (i.e. read and write) are done on a file, a thread or some other form of asynchronous worker process is started or spawned to update a data management system. The thread may update historical access entries with access information, where the thread may either time out waiting for additional accesses or exit to be started again in a subsequent access. The use of threads allows the data management system to run potentially in parallel. This data management system may be a component external to the normal file system, or part of the file system on which this file resides. The data management system, at configurable intervals or continuously, analyzes the historical I/O operation metadata for files and instructs the data management system to speculatively (e.g. a close point in time before actual file access) migrate or copy the file data in an optimal fashion for future access. The metadata management system may also chose to migrate associated data as configured by policy, or it may signal some external component such as a subscribed access control component (for example, a security manager for credentials or certificates), such that the subscribed access control component may use the metadata analysis results to optimally move or copy other data that is associated with this speculative access. For example a security component may wish to cache credentials or data used to validate credentials on a particular server. It should be noted that if data or associated data is copied rather than moved, copy on write semantics should be used to preserve data integrity.

In one embodiment, the present invention includes a database in the data management system, for example DB2 with Hierarchical Storage Manager (HSM) or Tivoli Storage Manager (TSM) by IBM. This database may contain fields and records associated with the file for historical access items such as time of historical accesses, type of access, length of access, security access control information, etc. The HSM or TSM may retrieve the files needed, for example at month's end, and place it from one storage device to another before the projected date of the need. This movement of data may be spread out over time during the scheduled day, filling in idle time in the HSM/TSM and storage device workload.

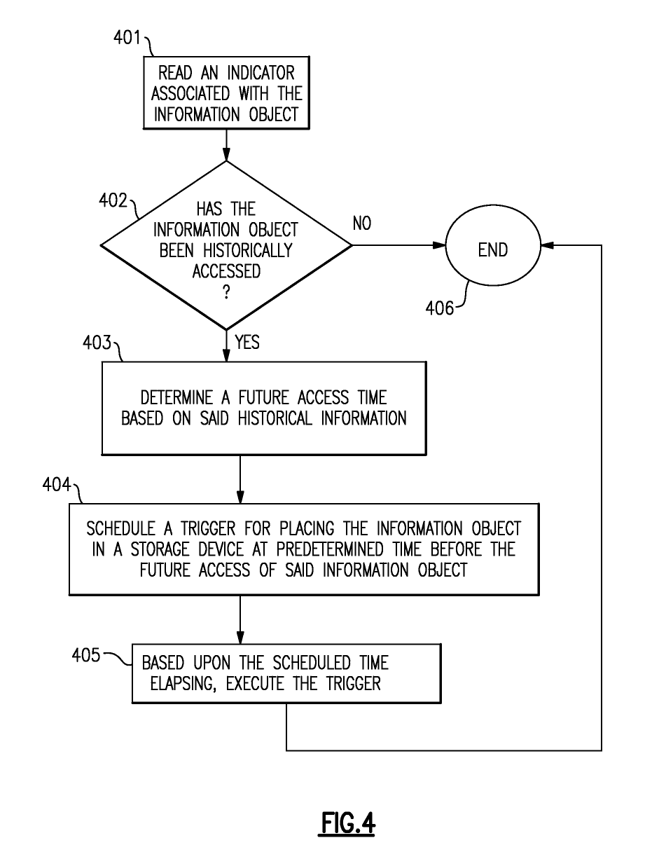

FIG. 4 illustrates a flowchart describing one or more aspects of the present invention. An indicator associated with the information object is read 401. The indicator indicates that historical information is stored for the information object. It is determined that the information object has been historically accessed 402. This determination may use historical information stored for the information object. If not, then flow ends 406. If yes, future access time is determined based on the historical information 403. A trigger for placing said information object in a storage device a predetermined time before the future access of the information object is then scheduled 404. The trigger is associated with a scheduled time. When the scheduled time elapses, the trigger is executed 405. The flow then ends 406.

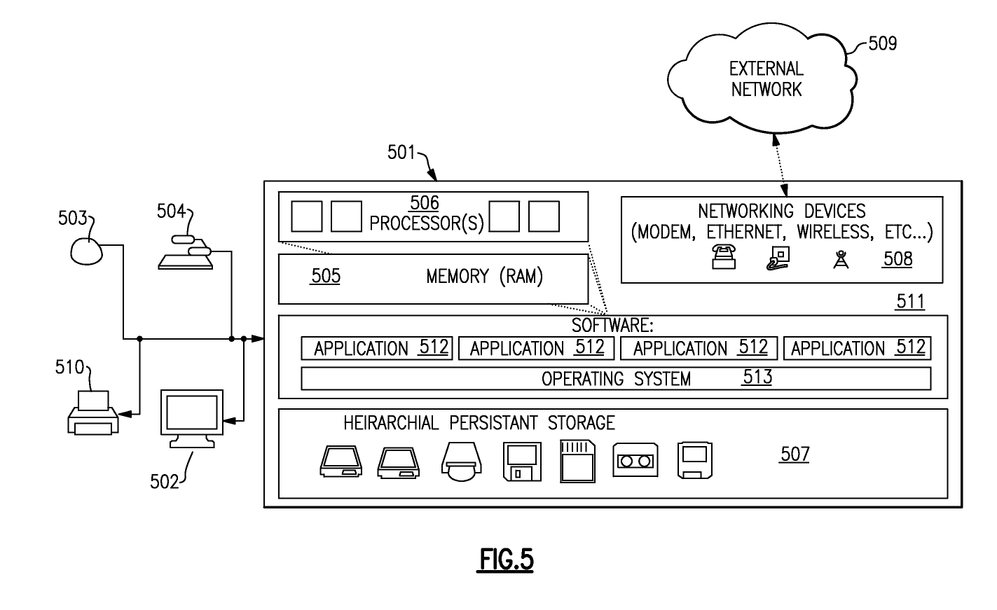

FIG. 5 illustrates a representative workstation or server hardware system in which the present invention may be practiced. The system of FIG. 5 comprises a representative computer system 501, such as a personal computer, a workstation or a server, including optional peripheral devices. The workstation 501 includes one or more processors 506 and a bus employed to connect and enable communication between the processor(s) 506 and the other components of the system 501 in accordance with known techniques. The bus connects the processor 506 to memory 505 and long-term storage 507 which can include a hard drive, diskette drive or tape drive for example. The system 501 might also include a user interface adapter, which connects the microprocessor 506 via the bus to one or more interface devices, such as a keyboard 504, mouse 503, a Printer/scanner 510 and/or other interface devices, which can be any user interface device, such as a touch sensitive screen, digitized entry pad, etc. The bus also connects a display device 502, such as an LCD screen or monitor, to the microprocessor 506 via a display adapter. The system 501 may also include a networking device 508, which connects the system 501 to an external network 509. The system 501 may also include software 511 in memory 505 run by processor 506. The software may include applications 512 and an operating system 513.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

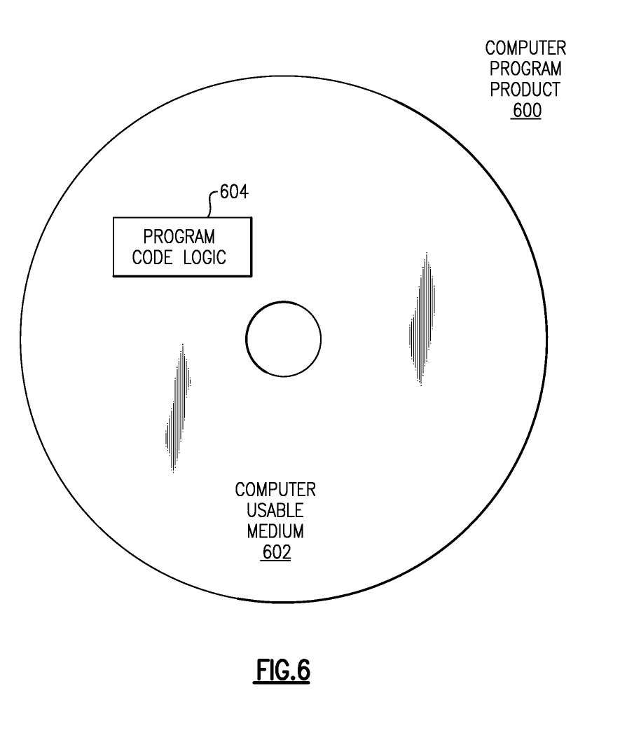

One example of a computer program product incorporating one or more aspects of an embodiment of the present invention is described with reference to FIG. 6. A computer program product 600 includes, for instance, one or more computer usable media 602 to store computer readable program code means or logic 604 thereon to provide and facilitate one or more aspects of an embodiment of the present invention. Any combination of one or more computer usable or computer readable medium(s) may be utilized. The computer-usable or computer-readable medium may be, for example but not limited to, an electronic, magnetic, optical, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device. In the context of this document, a computer-usable or computer-readable medium may be any storage medium that can contain or store the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method for storing and operating an information object, said method comprising:
reading an indicator associated with said information object, wherein said indicator indicates that a historical information is stored for said information object; and
responsive to determining from said historical information that said information object has been historically accessed, performing (a) through (c), comprising:
(a) determining a future access time based on said historical information,
(b) scheduling a trigger for placing said information object in a storage device at a predetermined time before said future access of said information object, wherein said trigger is associated with a scheduled time; and
(c) responsive to said scheduled time elapsing, executing said trigger, said executing trigger comprising placing said information object in said storage device.

2. The computer implemented method according to claim 1, further comprising updating a database comprising said historical information with an updated historical information regarding said information object responsive to said information object being accessed.

3. The computer implemented method according to claim 1, further comprising determining an optimal placement of said information object into said storage device based on a predetermined policy.

4. The computer implemented method according to claim 3, wherein said predetermined policy comprises a policy selected from the group consisting of a placement policy, a storage management policy, and a storage hierarchy.

5. The computer implemented method according to claim 1, wherein said historical information comprises a historical access time.

6. The computer implemented method according to claim 1, wherein said indicator is a bit.

7. The computer implemented method according to claim 1, wherein said predetermined time is determined based upon said historical information.

8. The computer implemented method according to claim 1, further comprising updating said historical information when said trigger is executed.

9. A system for storing and operating an information object comprising:
a memory;
a processor in communications with said memory, said processor capable of performing a method comprising:
reading an indicator associated with said information object, wherein said indicator indicates that a historical information is stored for said information object; and
responsive to determining from said historical information that said information object has been historically accessed, performing (a) through (c), comprising:
(a) determining a future access time based on said historical information,
(b) scheduling a trigger for placing said information object in a storage device at a predetermined time before said future access of said information object, wherein said trigger is associated with a scheduled time; and
(c) responsive to said scheduled time elapsing, executing said trigger, said executing trigger comprising placing said information object in said storage device.

10. The system according to claim 9, further comprising updating a database comprising said historical information with an updated historical information regarding said information object responsive to said information object being accessed.

11. The system according to claim 9, further comprising determining an optimal placement of said information object into said storage device based on a predetermined policy.

12. The system according to claim 11, wherein said predetermined policy comprises a policy selected from the group consisting of a placement policy, a storage management policy, and a storage hierarchy.

13. The system according to claim 9, wherein said historical information comprises a historical access time.

14. The system according to claim 9, wherein said indicator is a bit.

15. The system according to claim 9, wherein said predetermined time is determined based upon said historical information.

16. The system according to claim 9, further comprising updating said historical information when said trigger is executed.

17. A computer program product for storing and operating an information object, the computer program product comprising:
a storage medium readable by a processing circuit and storing instructions for execution by the processing circuit for performing a method comprising:
reading an indicator associated with said information object, wherein said indicator indicates that a historical information is stored for said information object; and
responsive to determining from said historical information that said information object has been historically accessed, performing (a) through (c), comprising:
(a) determining a future access time based on said historical information,
(b) scheduling a trigger for placing said information object in a storage device at a predetermined time before said future access of said information object, wherein said trigger is associated with a scheduled time; and
(c) responsive to said scheduled time elapsing, executing said trigger, said executing trigger comprising placing said information object in said storage device.

18. The computer program product according to claim 17, further comprising updating a database comprising said historical information with an updated historical information regarding said information object responsive to said information object being accessed.

19. The computer program product according to claim 17, further comprising determining an optimal placement of said information object into said storage device based on a predetermined policy.

20. The computer program product according to claim 19, wherein said predetermined policy comprises a policy selected from the group consisting of a placement policy, a storage management policy, and a storage hierarchy.
